(19) United States
(12) Patent Application Publication
(10) Pub. No.: US 2013/0128864 A1
(43) Pub. Date: May 23, 2013

(54) METHOD AND APPARATUS FOR HANDOVER BETWEEN HETEROGENEOUS NETWORKS

(71) Applicant: Samsung Electronics Co., Ltd, Gyeonggi-do (KR)

(72) Inventor: Donghyun Kim, Gyeonggi-do (KR)

(73) Assignee: SAMSUNG ELECTRONICS CO., LTD, Gyeonggi-do (KR)

(21) Appl. No.: 13/679,614

(22) Filed: Nov. 16, 2012

(30) Foreign Application Priority Data
Nov. 18, 2011 (KR) 10-2011-0120822

(51) Int. Cl. H04W 36/14

(52) U.S. Cl. CPC H04W 36/14
USPC 370/331

(57) ABSTRACT

Provided are a handover method between heterogeneous networks and an apparatus thereof. The handover method between heterogeneous networks includes receiving a handover request message indicating a handover request from an evolved Node B (eNB) to the heterogeneous network, transmitting a first indirect data forwarding tunnel request requesting generation of an indirect data forwarding tunnel between the heterogeneous networks to an enhanced Packet Data Gateway (ePDG) when the handover request message is received, receiving ePDG address information of a tunneling target ePDG from the ePDG, transmitting a second indirect data forwarding tunnel request including the ePDG address information to a serving gateway, receiving S-GW address information from the serving gateway, and transmitting a handover command including the S-GW address information to the eNB. The method can prevent data from being lost during handover procedure between heterogeneous networks.

### CROSS-REFERENCE TO RELATED APPLICATION(S) AND CLAIM OF PRIORITY

The present application is related to and claims priority under 35 U.S.C. §119(a) to a Korean Patent Application No. 10-2011-0120822 filed on Nov. 18, 2011, in the Korean Intellectual Property Office, the contents of which is incorporated herein by reference.

### TECHNICAL FIELD OF THE INVENTION

The present disclosure relates to a handover method between heterogeneous networks and an apparatus thereof.

### BACKGROUND OF THE INVENTION

Handover refers to a procedure which forwards a call signal from one base station to another base station as a user moves beyond a range or network software resets call path. In general, a synchronous scheme uses handoff and an asynchronous scheme uses handover. Handover refers to a procedure of changing a call path to a new cell to continuously maintain the call when a mobile station moves to another base station (or sector) beyond a base station (or sector) zone which is serving.

A handover scheme between a Long Term Evolution (LTE) network and a non-3GPP network is partially described in a current 3^{rd} Generation Partnership Project (3GPP) standard. According to an existing handover scheme between the LTE network and the non-3GPP, a user equipment (UE) performs connection with a target network without preliminary preparation for handover.

When the handover is performed between the LTE network and the non-3GPP, because a connection network is changed, the UE needs to perform an authentication procedure through a new network and open a data path after completing the authentication procedure. That is, a single radio UE accesses a target network non-3GPP network without a procedure for retransmitting data. In this case, traffic generated while a network connection and authentication procedure is performed is lost. A method of retransmitting data during handover between a current LTE network and an evolved High Rate Packet Data (eHRPD) network through S101 and S103 interfaces is described in standard documents. However, there is no scheme for handover between other non-3GPP network and an LTE network which is widely known or used.

### SUMMARY OF THE INVENTION

To address the above-discussed deficiencies of the prior art, it is a primary object to provide a handover apparatus for preventing data from being lost in a handover procedure between heterogeneous networks and a method thereof.

In accordance with an aspect of the present disclosure, a handover method between heterogeneous networks, includes receiving a handover request message indicating a handover request from an evolved Node B (eNB) to the heterogeneous networks, transmitting a first indirect data forwarding tunnel request requesting generation of an indirect data forwarding tunnel between the heterogeneous networks to an enhanced Packet Data Gateway (ePDG) when the handover request message is received, receiving ePDG address information of a tunneling target ePDG from the ePDG, transmitting a second indirect data forwarding tunnel request including the ePDG address information to a serving gateway, receiving S-GW address information from the serving gateway, and transmitting a handover command including the S-GW address information of the serving gateway to the eNB.

In accordance with another aspect of the present disclosure, a handover apparatus between heterogeneous networks, includes a communication unit configured to receive a handover request message indicating a request of handover from an evolved Node B (eNB) to the heterogeneous network, a handover unit determining whether the received handover request message is the request for handover into the heterogeneous network, and

a tunneling unit configured to transmit a first indirect data forwarding tunnel request requesting generation of an indirection data forwarding tunnel between the heterogeneous networks to an enhanced packet data gateway (ePDG) when receiving the handover request message, receive ePDG address information of a tunneling target ePDG from the ePDG, transmit a second indirect data forwarding tunnel request including the ePDG address information to a serving gateway, and receive S-GW address information from the serving gateway, wherein the handover unit transmits a handover command including the S-GW address information of the serving gateway to the eNB.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a handover procedure between a Wireless Fidelity (Wi-Fi) network and an LTE network according to the related art;

FIG. 2a illustrates a handover procedure for a heterogeneous networks system according to an exemplary embodiment of the present disclosure;

FIG. 2b is a flowchart illustrating a handover method for the heterogeneous networks system shown in FIG. 2a;

FIG. 3 is illustrates a Private Extension information element of an indirect data forwarding tunnel request according to an exemplary embodiment of the present disclosure; and

FIG. 4 is a high-level block diagram of an MME according to an exemplary embodiment of the present disclosure.

### DETAILED DESCRIPTION OF THE INVENTION

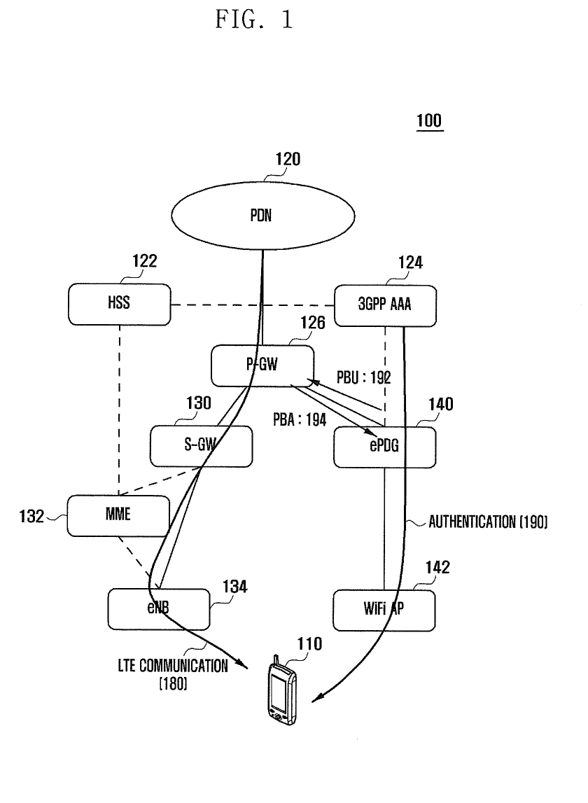

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication technology.

Exemplary embodiments of the present disclosure are described with reference to the accompanying drawings in detail. The same reference numbers are used throughout the drawings to refer to the same or like parts. Detailed descriptions of well-known functions and structures incorporated herein may be omitted to avoid obscuring the subject matter of the present disclosure.

FIG. 1 is illustrates a handover procedure between a Wireless Fidelity (Wi-Fi) network and an LTE network according to the related art.

A heterogeneous system 100 according to the related art includes a user equipment (UE) 110, a Packet Data Network (PDN) 120, a Home Subscriber Server (HSS) 122, a 3GPP (Authentication, Authorization and Accounting (AAA) 124, PDN-gateway (P-GW) 126, a Serving Gateway (S-GW) 130, a Mobility Management Entity (MME) 132, an evolved Node B (eNB) 134, an enhanced Packet Data Gateway (ePDG) 140 and a Wireless Fidelity Access Point (Wi-Fi AP) 142.

With reference to FIG. 1, the UE 110 receives data from the PDN 120 through the P-GW 126, the S-GW 130, and the eNB 134, and transmits the data to the PDN 120 (Path 180). Next, when connection state with the eNB 134 becomes bad, the UE 110 handovers to the Wi-Fi AP 142. Steps 190 to 194 are detailed steps for the handover. The UE 110 communicates with the 3GPP AAA server 124 to perform authentication. If the authentication is successfully performed, the ePDG 140 transmits a Proxy Binding Update (hereinafter referred to ‘PBU’) message to the P-GW 126 (192). The PBU message is a message for requesting that a path directing to the UE 110 be changed. The P-GW 126 having received the PBU message changes a path directing to the UE 110 and transmits a Proxy Binding Ack (hereinafter referred to ‘PBA’) message to the ePDG 140 as a response with respect to the PBU message (194).

As described above, according to the related art, the authentication (190) and path change (192 and 194) procedures are performed without retransmitting traffic packet. Accordingly, while the handover is being performed, the packet transferred to the S-GW 130 and the eNB 134 along an original path is not transferred to the UE 110 but lost.

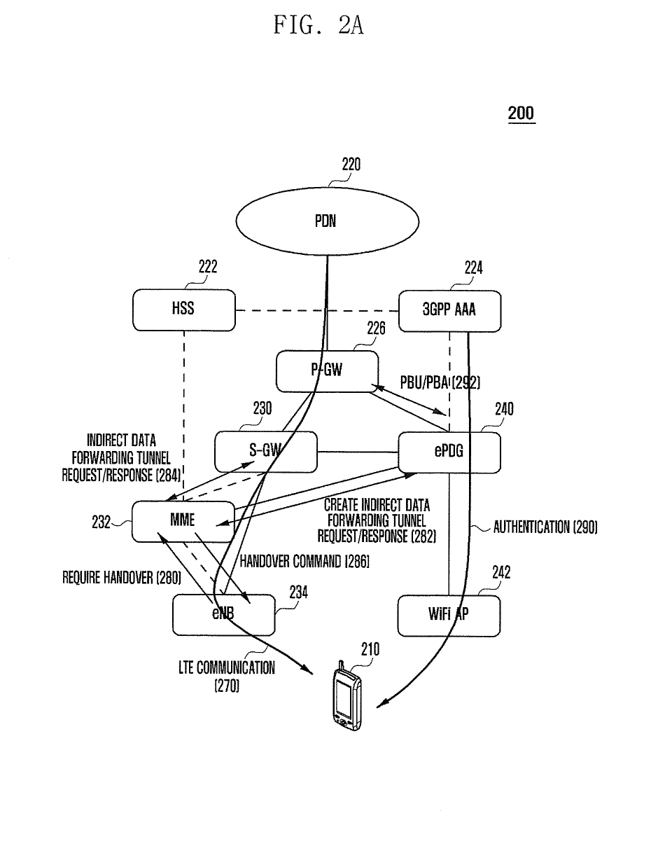

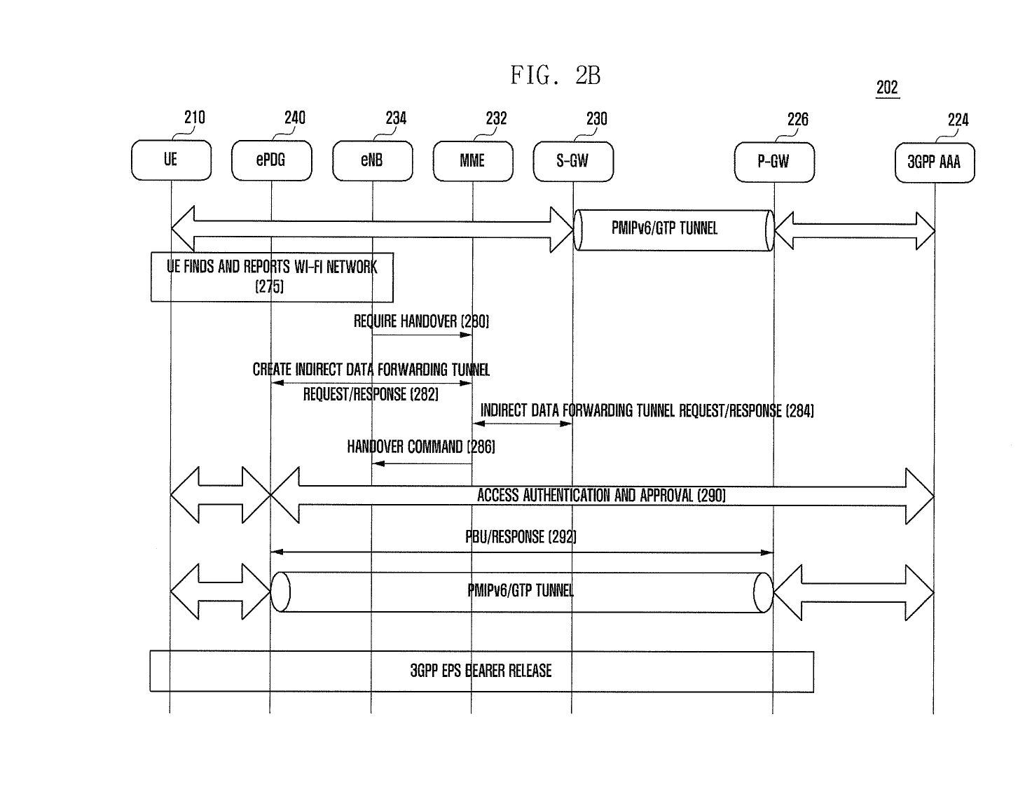

FIG. 2a is illustrates a communication system 200 including a heterogeneous network according to an exemplary embodiment of the present disclosure. FIG. 2b is a flowchart 202 illustrating a handover method into a heterogeneous network shown in FIG. 2a. A heterogeneous network system according to an exemplary embodiment of the present disclosure includes a UE 210, a PDN 220, an HSS 222, a 3GPP AAA server 224, a P-GW 226, an S-GW 230, an MME 232, an eNB 234, an ePDG 240 and a Wi-Fi AP 242.

Hereinafter, a handover method between the heterogeneous networks will be described with reference to FIGS. 2a and 2b. The UE 210 communicates with the PDN 220 through the P-GW 226, the S-GW 230 and the eNB 234 (Path 270). To enable communication, a Proxy Mobile IPv6 (PMIPv6)/General Packet Radio Service (GPRS) Tunneling Protocol (GTP) tunnel is formed between the P-GW 226 and the S-GW 230.

The UE 210 searches a Wi-Fi network including a Wi-Fi AP 242 and reports a found Wi-Fi network(s) to the eNB 234. The eNB 234 determines the necessity of performing handover based on a channel state between the UE 210 and the eNB 234 and between the UE 210 and the Wi-Fi AP 242. For example, if signal strength of the Wi-Fi AP 242 received by the UE 210 is stronger than that of the eNB 234 beyond a threshold, the eNB 234 can determine that the UE need to handover to the Wi-Fi AP 242. Determination of necessity of the handover can use one of well-known schemes. It is assumed that the eNB 234 determines to handover to a Wi-Fi AP 242 for the UE 210.

The eNB 234 having determined the handover transmits a handover request message to the MME 232 (280). The handover request message transferred at step 280 is a message indicating that the UE 210 needs to handover from the eNB 234 to the Wi-Fi AP 242. To inform the handover to a non-3GPP network, the eNB 234 sets a handover type parameter of a handover request message to a specified value, for example, ‘LTEtoNON3GPP’, and transfers the specified value of ‘LTEtoNON3GPP’ to the MME 232. A following table 1 describes exemplary values for a handover type parameter of the handover request message.

TABLE 1

| IE/Group | |
|---|---|
| Name | IE type and reference |
| Handover | ENUMERATED (IntraLTE, LTEtoUTRAN, LTEtoGERAN, |
| Type | UTRANtoLTE, GERANtoLTE, LTEtoNON3GPP) |

‘LTEtoNON3GPP’ can be used as the value of the handover type parameter is not used or known in a communication scheme according to the related art. When receiving a handover request message with the handover type parameter of ‘LTEtoNON3GPP’, the MME 232 is able to know that the handover request message requires handover from an LTE network to a network other than 3GPP, for example, a Wi-Fi network. The term ‘LTEtoNON3GPP’ is for an example only. Other examples using different parameters could be used for the eNB 234 to inform a handover request from the LTE network to a Wi-Fi network without departing from the scope of this disclosure.

The MME 232 having received a handover request message into the Wi-Fi network transmits a Create Indirect Data Forwarding Tunnel Request to the ePDG 240 and receives an Indirect Data Forwarding Tunnel Response as a response thereof (282). The MME 232 determines whether the received handover request message indicates handover from an LTE network into a heterogeneous network. If the received handover request message does not indicate a handover into the heterogeneous network, the MME 232 performs the handover according to the related art scheme. In the embodiment of FIGS. 2a and 2b, the received handover request message indicates handover to a heterogeneous network. If the received handover request message indicates the handover into the heterogeneous network, the MME performs following steps 282, 284 and 286 to generate an indirect data forwarding tunnel. The MME 232 may determine whether the received handover request message indicates handover into the heterogeneous network, for example, based on a handover type parameter of the handover request message.

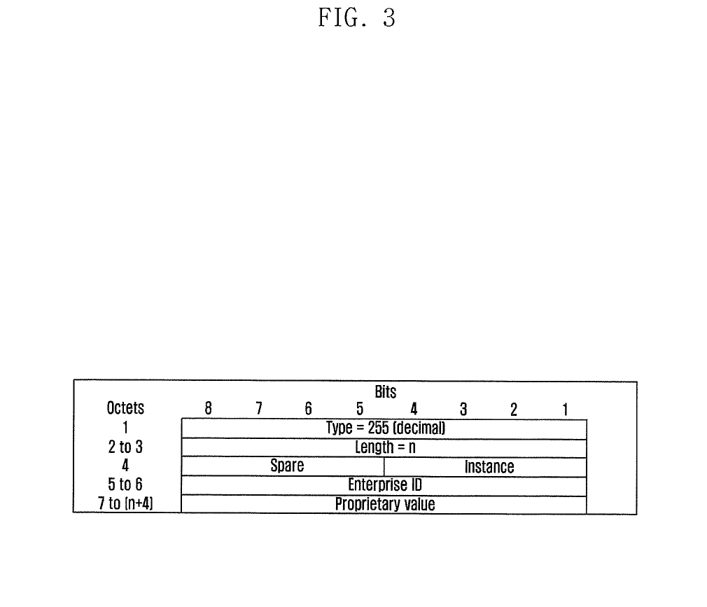

FIG. 3 illustrates an exemplary file structure for a Private Extension information element (IE) of an indirect data forwarding tunnel request according to an exemplary embodiment of the present disclosure.

The indirect data forwarding tunnel request is a message for requesting for opening a forwarding path (tunnel) between the ePDG 240 and the S-GW 230. In some embodiments, the indirect data forwarding tunnel request can include a Private Extension IE of the form as shown in FIG. 3. The Private Extension IE includes a spare field. The MME 232 can set the spare field to a specific value, for example, ‘1’ to inform that a corresponding indirect data forwarding tunnel request requests the handover from the LTE network to a non-3GPP network (a heterogeneous network). According to another embodiment, different field or different message can be used to inform the handover into the heterogeneous network to the ePDG 240.

The ePDG 240 having received the indirect data forwarding tunnel request transmits an indirect data forwarding tunnel response to the MME 232. The indirect data forwarding tunnel response includes address information, for example, IP address of an ePDG and/or a GTP Tunnel Endpoint IDentifier (TEID). The ePDG 240 can allocate the IP address of an ePDG and/or the GTP TEID to an ePDG used for tunneling. The ePDG 240 having received the indirect data forwarding tunnel request is not always necessary to be used in the tunneling. A case where the ePDG 240 is used in the tunneling is assumed for convenience. In some embodiments, because the MME 232 has information about non-3GPP network neighboring the eNB 230 in advance, information about a target non-3GPP network can be added to a Bearer Context IE.

The MME 232 having received the IP address and/or the GTP TEID from the ePDG 240 transmits an indirect data forwarding tunnel request to the S-GW 230, and receives an indirect data forwarding tunnel response in response to the indirect data forwarding tunnel request (284). The indirect data forwarding tunnel request includes an IP address and/or GTP TEIP of the ePDG 240 received from the ePDG 240.

The S-GW 230 having received the indirect data forwarding tunnel request transmits an indirect data forwarding tunnel response to the MME 232. The indirect data forwarding tunnel response include address information, for example, TEID of the S-GW 230 which is necessary when the eNB 234 performs data forwarding. The S-GW 230 generates an indirect data forwarding tunnel between the S-GW 230 and the ePDG 240 using the received IP address or GTP TEID of the ePDG 240.

For example, a general PMIPv 6 path opening message or a general GTP path opening message can be used as a message for generating an indirect data forwarding tunnel. An indirect data forwarding tunnel opened by this procedure is used to transfer and buffer data of the UE 210 to the ePDG 240 as a destination while the handover is being performed.

The MME 232 transmits a handover command to the eNB 234 (286). The handover command includes a TEID of the S-GW 230 necessary when the eNB 234 performs forwarding.

The UE 210 communicates with the 3GPP AAA server 224 to perform access authentication and approval process(290).

If the access authentication and approval process are completed, the ePDG 240 transmits PBU to the P-GW and receives PBA from the P-GW 226 as a response thereof (292). The ePDG 240 transfers forwarding data received from the S-GW 230 to the UE 210 through an indirect data forwarding tunnel. Through PBU/PBA exchange, if opening of PMIPv6 path between the ePDG 240 and the P-GW 226 is completed, the handover process is complete. According to another embodiments, the ePDG 240 can be connected to the P-GW 226 through a GTP path instead of a PMIPv6 path. In this case, the ePDG 240 transmits a Create Session Request message instead of the PBU to the P-GW 226 and receives a Create Session Response message from the P-GW 226 to open a GTP path.

After the handover process is complete, 3GPP Evolved Packet System (EPS) bearer between the UE 210 and the P-GW 226 is released.

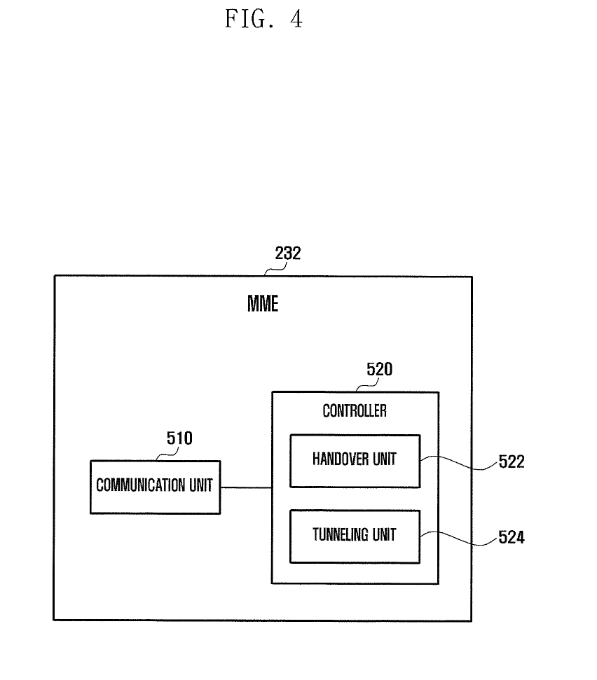

FIG. 4 illustrates a high-level block diagram of an MME 232 according to an exemplary embodiment of the present disclosure. An MME 232 according to an embodiment of the present disclosure includes a communication unit 510 and a controller 520. Although more constituent elements are needed for an operation of the MME 232 according to the related art, constituent elements which are not associated with a gist of the present disclosure may be omitted to avoid obscuring the subject matter of the present disclosure.

The communication unit 510 exchanges data with other constituent elements in the communication system 200. For example, as illustrated with reference to FIGS. 2a and 2b, the communication unit 510 receives a handover request message from the eNB 234. The communication unit 510 transmits a handover command to the eNB 234. As illustrated with reference to FIGS. 2a and 2b, the communication unit 510 exchanges the indirect data forwarding tunnel request/response with the S-GW 230 and the ePDG 240. In the foregoing description, transmission/reception operations of the MME 232 are performed through the communication unit 510. The communication unit 510 transmits received data to the controller 520. The communication unit 510 transmits/receives data under control of the controller 520.

The controller 520 includes a handover unit 522 and a tunneling unit 524. The handover unit 522 analyzes the received handover request message to determine whether handover between heterogeneous networks will be performed. A method of analyzing the request message has been described with reference to FIGS. 2a to FIG. 3, particularly in the description of step 282. When the handover request message indicates one of existing handovers, the controller 520 processes the handover according to the related art schemes. Alternatively, when the handover request message indicates a handover between heterogeneous networks, the controller 520 processes the handover as described above with reference to FIGS. 2a and 2b. Specifically, the handover unit 522 transmits the handover command to the eNB 234 as described in connection with step 286 of FIGS. 2a and 2b.

When the handover request message indicates a handover between heterogeneous networks, the tunneling unit 524 controls the communication unit 510 to transmit an indirect data forward tunneling request to the S-GW 230 and the e-PDG 240 and to receive an indirect data forwarding tunnel response from the S-GW 230 and the e-PDG 240. A detailed message transmission/reception procedure is described in connection with steps 282 and 284 of FIGS. 2a and 2b.

In the foregoing embodiments, the MME 232 performs an overall operation of handover process. However, according to another embodiment, a constituent element other than the MME 232 can perform the operation of the MME 232 instead. The foregoing embodiment has illustrated that the UE handovers from the LTE network to a Wi-Fi network by way of example. However, when a scheme of the foregoing embodiment is applied, the present disclosure can be used for handover between other networks.

According to embodiments of the present disclosure, the present disclosure can prevent data from being lost in a handover procedure between heterogeneous networks.

Since computer program instructions can be mounted in a processor of a universal computer, a special computer or other programmable data processing equipment, instructions performed through a processor of a computer or other programmable data processing equipment generates means for performing functions described in block(s) of the flowcharts. Since the computer program instructions can be stored in a computer available or computer readable memory capable of orienting a computer or other programmable data processing equipment to implement functions in a specific scheme, instructions stored in the computer available or computer readable memory can produce manufacturing articles involving an instruction means executing functions described in block(s) of flowcharts. Because the computer program instructions can be mounted on a computer or other programmable data processing equipment, a series of operation steps are performed in the computer or other programmable data processing equipment to create a process executed by the computer such that instructions performing the computer or other programmable data processing equipment may provide steps for executing functions described in block(s) of flowcharts.

Further, each block can indicate a part of a module, a segment, or a code including at least one executable instruction for executing specific logical function(s). It should be noticed that several execution examples can generate functions described in blocks out of an order. For example, two continuously shown blocks can be simultaneously performed, and the blocks can be performed in a converse order according to corresponding functions.

As used in this embodiment, the term “˜ unit” refers to software or a hardware structural element such as FPGA or ASIC, and the “˜ unit” perform some roles. However, the “˜ unit” is not limited to software or hardware. The “˜ unit” can be configured to be stored in an addressable storage medium and to play at least one processor. Accordingly, for example, the “˜ unit” includes software structural elements, object-oriented software structural elements, class structural elements, task structural elements, processes, functions, attributes, procedures, subroutines, segments of a program code, drivers, firmware, microcode, circuit, data, database, data structures, tables, arrays, and variables. Functions provided in structural elements and “˜ units” may be engaged by the smaller number of structural elements and “˜ units”, or may be divided by additional structural elements and “˜ units”. Furthermore, structural elements and “˜ units” may be implemented to play a device or at least one CPU in a security multimedia card.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for handover between heterogeneous networks, the method comprising:
receiving a handover request message indicating a handover from an evolved Node B (eNB) into a heterogeneous network;
transmitting a first indirect data forwarding tunnel request requesting generation of an indirect data forwarding tunnel between the heterogeneous networks to an enhanced Packet Data Gateway (ePDG) when the handover request message is received;
receiving ePDG address information of a tunneling target ePDG from the ePDG;
transmitting a second indirect data forwarding tunnel request including the ePDG address information to a serving gateway (S-GW);
receiving S-GW address information from the serving gateway; and
transmitting a handover command including the S-GW address information to the eNB.

2. The method of claim 1, wherein the serving gateway having received the second indirect data forwarding tunnel request generates an indirect data forwarding tunnel, and transmits data received from the UE during handover process to the tunneling target ePDG through the indirect data forward tunnel.

3. The method of claim 2, wherein the eNB having received the handover command forwards the data received from the UE to the S-GW.

4. The method of claim 1, wherein the handover controller determines whether a handover request message requests the handover into the heterogeneous network based on a handover type parameter of the handover request message.

5. The method of claim 1, wherein the first indirect data forwarding tunnel request includes Private Extension Information Element (IE) with a space field set to be a value indicating handover between the heterogeneous networks.

6. A handover apparatus for controlling handover between heterogeneous networks, the handover apparatus comprising:
a communication unit configured to receive a handover request message indicating a request of handover from an evolved Node B (eNB) to heterogeneous network;
a handover unit configured to determine whether the received handover request message is the request for handover to the heterogeneous network; and
a tunneling unit configured to transmit a first indirect data forwarding tunnel request for generation of an indirection data forwarding tunnel between the heterogeneous networks to an enhanced packet data gateway (ePDG) when receiving the handover request message, receive ePDG address information of a tunneling target ePDG from the ePDG, transmit a second indirect data forwarding tunnel request including the ePDG address information to a serving gateway, and receive S-GW address information from the serving gateway,
wherein the handover unit is configured to transmit a handover command including the S-GW address information to the eNB.

7. The handover apparatus of claim 6, wherein the serving gateway having received the second indirect data forwarding tunnel request is configured to generate an indirect data forwarding tunnel, and transmit data transmitted from the UE during handover process to the tunneling target ePDG through the indirect data forward tunnel.

8. The handover apparatus of claim 7, wherein the eNB having received the handover command is configured to forward the data transmitted from the UE to the S-GW.

9. The handover apparatus of claim 6, wherein the handover unit is configured to determine whether a handover request message indicates the handover into the heterogeneous network based on a handover type parameter of the received handover request message.

10. The handover apparatus of claim 6, wherein the tunneling unit is configured to transmit Private Extension Information Element (IE) with a space field set to be a value indicating handover between the heterogeneous networks.
